(19) United States
(12) Patent Application Publication
(10) Pub. No.: US 2008/0016471 A1
(43) Pub. Date: Jan. 17, 2008

(54) Electronic device for providing 3D user interface and method of providing a 3D user interface

(75) Inventor: Bo-eun Park, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/634,140

(22) Filed: Dec. 6, 2006

(30) Foreign Application Priority Data
Jul. 14, 2006 (KR) 2006-66548
Aug. 30, 2006 (KR) 2006-83053

(51) Int. Cl. G06F 3/048

(52) U.S. Cl. 715/848; 715/836

(57) ABSTRACT

Electronic devices providing three-dimensional user interface and methods therefore are provided. The electronic device includes a graphical user interface (GUI) unit for producing a GUI, the GUI including a device layer for displaying device information using at least one of side surfaces of a first polygonal pillared shape, and a content layer for displaying content information using at least one of side surfaces of a second polygonal pillared shape; and a control unit for controlling the GUI producing operation of the GUI unit. The devices allow for efficiently operating menus and operating personalized menus according to user's preferences by providing a three-dimensional GUI having a plurality of independently movable layers.

### CROSS-REFERENCE TO RELATED APPLICATIONS

This application claims the benefit under 35 U.S.C. §119(a) of Korean Patent Application No. 10-2006-66548, filed Jul. 14, 2006, and Korean Patent Application No. 10-2006-83053, filed Aug. 30, 2006, in the Korean Intellectual Property Office, the entire disclosures of both of which are incorporated herein by reference.

### BACKGROUND OF THE INVENTION

1. Field of the Invention

The present invention relates to electronic devices. More particularly, the present invention relates to electronic devices for providing a three-dimensional user interface.

2. Description of the Related Art

A user interface (UI) collectively refers to means for interfacing between an electronic device and a user. It allows the user to send a user command to the electronic device and information from the device to the user. Representative examples of the UI include physical user interface (PUI) and graphical user interface (GUI).

The PUI refers to a means for inputting a user command in a physical way, such as a keyboard, operation buttons, and a touch pad. The GUI refers to a means for inputting a user command by, for example, selecting an icon or a menu displayed on a display device.

Inputting a user command on the GUI necessarily requires a PUI. This is because a move command and a select command can be input only through the PUI in a GUI in which a user needs to move a pointer (cursor) and select an item on which the pointer is located while referring to a menu, a list, an icon, and the like displayed on a display device.

Meanwhile, an electronic device such as a personal computer may be connected to a plurality of external devices, such as a digital camera, an MP3 player, a printer, a mobile phone, a USB device, and so on. Accordingly, a user's demand is increasing to conveniently operate menus associated with the plurality of external devices connected to the electronic device.

However, since a GUI provided by a conventional electronic device is set to sequentially access desired data along a predefined group of menus, it is inconvenient to operate the menu upon accessing, at the electronic device, data stored in a plurality of external devices.

Furthermore, the GUI provided by conventional electronic device does not consider users' preferences in operating a menu. Accordingly, there is a need for a user interface that considers users' preferences.

### SUMMARY OF THE INVENTION

Embodiments of the present invention have been developed in order to substantially solve the above and other problems associated with the conventional arrangement and to provide the objectives listed below. An aspect of exemplary embodiments of the present invention is to provide an electronic device supporting a three-dimensional GUI which is capable of easily accessing data stored in a plurality of external devices connected thereto and providing a personalized menu in consideration of the user's preferences.

The above object of the present invention is substantially realized by providing an electronic device comprising a graphical user interface (GUI) unit for producing a GUI, the GUI including a device layer for displaying device information using at least one of side surfaces of a first polygonal pillared, and a content layer for displaying content information using at least one of side surfaces of a second polygonal pillared; and a control unit for controlling the GUI producing operation of the GUI unit.

In an exemplary implementation, the content layer may display at least one of a still image (photo), a moving image (movie), music (MP3), and text, and the device layer may display devices including a storage medium for storing at least one of the still image, moving image, music, and text.

In an exemplary implementation, the GUI generated by the GUI unit may further comprise a task layer for displaying task information using at least one of side surfaces of a third polygonal pillared. Here, the task layer may display at least one of slide show, CD burning, and new-folder making.

In an exemplary implementation, each of the first polygonal pillared shape and the second polygonal pillared shape may be any one of a triangular pillared shape, a tetragonal pillared shape, a pentagonal pillared shape, and a hexagonal pillared shape.

In an exemplary implementation, the first polygonal pillared shape and the second polygonal pillared shape preferably have the same structure.

The above object of the present invention is substantially realized by providing a user interface method comprising (a) displaying device information using at least one of side surfaces of a first polygonal pillared shape; and (b) displaying content information using at least one of side surfaces of a second polygonal pillared shape.

In an exemplary implementation, the content layer may display at least one of a still image (photo), a moving image (movie), music (MP3), and text, and the device layer may display devices including a storage medium for storing at least one of the still image, moving image, music, and text.

In an exemplary implementation, step (b) may further comprise displaying a content corresponding to the content information displayed on the side surface of the second polygonal pillared shape among contents included in a selected device when any one of devices displayed on the side surface of the first polygonal pillared shape is selected.

In an exemplary implementation, the method may further comprise displaying task information using at least one of side surfaces of a third polygonal pillared shape. Here, a task layer may display at least one of slide show, CD burning, and new-folder making.

The above object of the present invention is substantially realized by providing an electronic device comprising a GUI unit for producing a GUI, the GUI including a menu for indicating a menu item using at least one of side surfaces of a first polygonal pillared shape, and a submenu for indicating a submenu item using at least one of side surfaces of a second polygonal pillared shape; and a control unit for controlling the GUI producing operation of the GUI unit.

In an exemplary implementation, the GUI generated by the GUI unit may further comprise another menu for indicating another menu item using at least one of side surfaces of a third polygonal pillared shape. Here, another menu may be a submenu of either the menu item or the submenu item.

The above object of exemplary embodiments of the present invention is substantially realized by providing a user interface method comprising (a) displaying content information for a first type of contents stored in a first device when a selected one of a plurality of devices is the first device; and (b) when the selected device is switched into a second device, displaying content information for a first type of contents stored in the second device.

In an exemplary implementation, the method may further comprise receiving a selection of one of the first device and the second device, wherein step (a) may comprise displaying the content information for a first type of contents stored in the first device when the selection of the first device is received, and step (b) may comprise displaying the content information for a first type of contents stored in the second device when the selection is switched from the first device to the second device.

The above object of the present invention is substantially realized by providing an electronic device comprising a GUI unit for producing a GUI, the GUI including a device layer for displaying device information and a content layer for displaying content information; and a control unit for controlling the GUI unit to display a content corresponding to a selected device when one of devices of the device layer is selected.

In an exemplary implementation, the GUI generated by the GUI unit may further comprise a task layer for displaying task information, the control unit controls the GUI unit to display at least one of a still image (photo), a moving image (movie), music (MP3), and text on the content layer, and the control unit controls the GUI unit to display at least one of slide show, CD burning, and new-folder making on the task layer.

In an exemplary implementation, the control unit may control the GUI unit to display a content corresponding to the content type indicated on the content layer among the contents included in a selected device when any one of devices displayed on the device layer is selected.

The above object of exemplary embodiments of the present invention is substantially realized by providing a user interface method comprising displaying a first type of submenu belonging to the first menu item when a selected one of a plurality of menu items is the first menu item; and, when the first selected menu item is changed into a second menu item, displaying a first type of submenu belonging to the second menu item.

The above object of the present invention is substantially realized by providing an electronic device comprising a GUI unit for displaying a GUI including a plurality of layers; and a control unit for controlling the GUI unit to switch the at least one of the plurality of layers.

In an exemplary implementation, the control unit may control to switch selected ones of the plurality of layers and not to switch non-selected ones.

In an exemplary implementation, the plurality of layers may be independently switched.

In an exemplary implementation, the plurality of layers may include at least one of a device layer for displaying a type of a device, a content layer for displaying a type of a content, and a task layer for displaying a type of a task.

In an exemplary implementation, the control unit may control to display at least one of a device model name, a memory capacity, and a product image on the device layer.

In an exemplary implementation, under control of the control unit, the GUI unit may display information about devices and external devices connected to the devices on the device layer, information about contents stored in the device set at the device layer on the content layer, and tasks supported by the devices on the task layer.

In an exemplary implementation, the switching command may include at least one of a device switching command, a content switching command, and a task switching command corresponding to each of the plurality of layers.

In an exemplary implementation, the switching command may include direction information for rotating each layer.

In an exemplary implementation, when the device switching command is received, the control unit may control to rotate the device layer based on the direction information contained the device switching command in order to switch it, and to keep functions set in the content layer and the task layer as they are.

In an exemplary implementation, when the device switching command is received, the control unit may control the GUI unit to display contents of the type indicated by the content layer among contents stored in the switched device on the content layer.

In an exemplary implementation, the device may further comprise an operating unit for receiving a switching command for switching the plurality of layers, and the control unit may control the GUI unit to rotate a layer corresponding to the switching command.

In an exemplary implementation, the plurality of layers may form any one of a three-dimensional GUI and a two-dimensional GUI.

In an exemplary implementation, when the plurality of layers form a three-dimensional GUI, they may have a hexahedral structure.

In an exemplary implementation, the control unit may control to switch the type of at least one of the plurality of layers.

The above object of the present invention is substantially realized by providing a user interface method comprising displaying a GUI including a plurality of layers; and controlling the displaying to switch at least one of the plurality of layers.

In an exemplary implementation, the control unit may control to switch selected ones of the plurality of layers and not to switch non-selected ones.

In an exemplary implementation, the plurality of layers may be independently switched.

In an exemplary implementation, the plurality of layers may include at least one of a device layer for displaying a type of device, a content layer for displaying a type of content, and a task layer for displaying a type of task.

In an exemplary implementation, the controlling may control to display at least one of a device model name, a memory capacity, and a product image on the device layer.

In an exemplary implementation, under control of the controlling step, the displaying step may display information about devices and external devices connected to the devices on the device layer, information about contents stored in the device set at the device layer on the content layer, and tasks supported by the devices on the task layer.

In an exemplary implementation, the switching command may include at least one of a device switching command, a content switching command, and a task switching command corresponding to each of the plurality of layers.

In an exemplary implementation, the switching command may include direction information for rotating each layer.

In an exemplary implementation, when the device switching command is received, the controlling controls to rotate the device layer based on the direction information contained the device switching command in order to switch it, and to keep functions set in the content layer and the task layer as they are.

In an exemplary implementation, when the device switching command is received, the controlling may control the displaying to display contents of the type indicated by the content layer among contents stored in the switched device on the content layer.

In an exemplary implementation, the method may further comprise receiving a switching command for switching the plurality of layers, and the controlling may control the displaying to rotate a layer corresponding to the switching command.

In an exemplary implementation, the plurality of layers may form any one of a three-dimensional GUI and a two-dimensional GUI.

In an exemplary implementation, when the plurality of layers form a three-dimensional GUI, they may have a hexahedral structure.

In an exemplary implementation, the controlling may control to switch the type of at least one of the plurality of layers.

### BRIEF DESCRIPTION OF THE DRAWINGS

The above aspects and features of embodiments of the present invention will become more apparent by describing certain exemplary embodiments of the present invention with reference to the accompanying drawings, in which:

FIG. 1 is a block diagram illustrating an electronic device according to an exemplary embodiment of the present invention;

FIG. 2 is a diagram illustrating the structure of a three-dimensional GUI according to an exemplary embodiment of the present invention;

FIG. 3 is a diagram illustrating one example of a three-dimensional GUI in which a menu is operated for a function of a content layer in an electronic device according to exemplary embodiment of the present invention;

FIG. 4 is a diagram illustrating one example of a three-dimensional GUI in which a menu is operated for a function of a task layer in an electronic device according to exemplary embodiment of the present invention;

FIG. 5 is a diagram illustrating one example of a three-dimensional GUI in which a menu is operated for a function of a device layer in an electronic device according to an exemplary embodiment of the present invention;

FIG. 6 is a diagram illustrating a user interface according to another exemplary embodiment of the present invention; and

FIG. 7 is a diagram illustrating a two-dimensional GUI supporting multi-tasking according to another exemplary embodiment of the present invention.

Throughout the drawings, like reference numbers will be understood to refer to like elements, features and structures.

### DETAILED DESCRIPTION OF EXEMPLARY EMBODIMENTS

Exemplary embodiments of the present invention will now be described in detail with reference to the annexed drawings. In the following description, detailed descriptions of known functions and configurations incorporated herein have been omitted for conciseness and clarity.

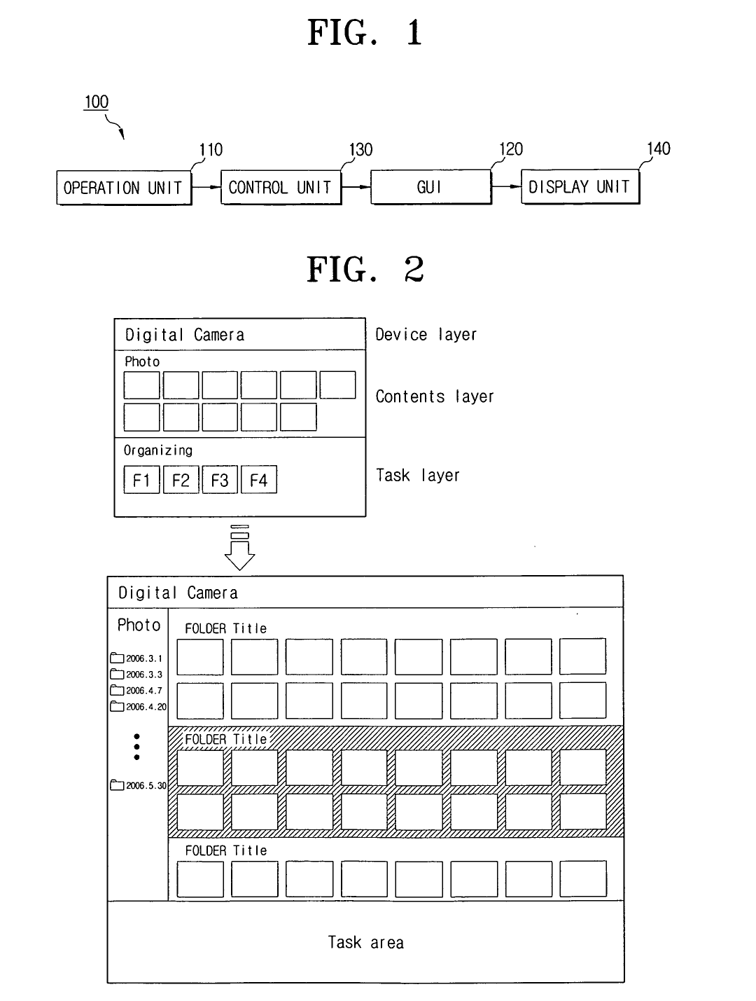

FIG. 1 is a block diagram illustrating an electronic device 100 according to an exemplary embodiment of the present invention. Referring to FIG. 1, the electronic device 100 includes an operation unit 110, a GUI 120, a control unit 130, and a display unit 140. In an exemplary implementation, the three-dimensional GUI provided by the electronic device 100 has a hexahedral structure including at least one layer, but the present invention is not limited thereto. For convenience of illustration, a description of the electronic device will be limited to a device layer, a content layer, and a task layer.

Here, the device layer is provided with information about the electronic device 100 and external devices connected to the electronic device 100, the content layer is provided with information about contents stored in the electronic device 100 and the external devices connected to the electronic device 100, and the task layer is provided with information about a task for executing a function corresponding to a user command input by a user on the electronic device 100 and the external device connected to the electronic device 100. The information provided to each layer is information about a device, content, and task selected by the user.

The operation unit 110 preferably includes key buttons, a touch panel, and a mouse and is used to receive a user command, and select or execute a user-indicated one of the items displayed on the three-dimensional GUI.

Further, the operation unit 110 transmits a device switching command, a content switching command, and a task switching command input by the user on the layers displayed in the three-dimensional GUI to the control unit 130. Each switching command includes direction information for rotating each layer.

Under control of the control unit 130, the GUI unit 120 displays the three-dimensional GUI having the plurality of layers on the display unit 140.

The three-dimensional GUI is displayed and changed three-dimensionally on a three-dimensional space. Specifically, the three-dimensional GUI allows a ‘three-dimensional GUT screen’ or ‘a content displayed on the three-dimensional GUI screen’ to move on an X axis, a Y axis, a Z axis, or a combination thereof or to be changed while moving. The content displayed on the ‘three-dimensional GUI screen’ may include an icon, a menu, a list, a pointer (cursor), an image, and so on.

When contents exist beyond the size of the content layer, the GUI unit 130 displays a sliding bar on a vertical axis or a horizontal axis of the content layer so that the content layer may be scrolled and/or zoomed in/out to display the contents.

The GUI unit 130 also displays content folders and contents organized by the control unit 130 on a predetermined area of the content layer. In this case, the GUI unit 130 displays the type of the set content on a predetermined area of the content layer together.

The control unit 130 controls the GUI unit 120 to display the three-dimensional GUI having the switched layer on the display unit 140 in response to a switching command received from the operation unit 110.

Specifically, upon receipt of the device switching command, the control unit 130 rotates the device layer in a direction indicated by the device switching command to switch the device, and controls the GUI 120 to display information about a model name of the switched device, memory capacity, and product images. In this case, the control unit 130 keeps the content layer and the task layer as they are, and controls to rotate only the device layer when the device switching command is received.

That is, the control unit 130 rotates the device layer of the reference plane so that information about the switched device is located on the device layer. The control unit 130 allows the user to execute a content and a task for a previous device on the switched device by not rotating the content layer and the task layer. Here, the reference plane including the currently selected device, content, and task receives the user command through the operation unit 110 and displays a processing result to the user.

Upon receipt of a content switching command, the control unit 130 controls the GUI unit 120 to rotate the content layer in a direction indicated by the content switching command to switch the content and to display items of the switched content. Here, the content items include a still image, a moving-image, music, text, and so on. The control unit 130 keeps the device layer and the task layer as they are, and rotates only the content layer when the content switching command is received.

The control unit 130 also controls the GUI unit 120 to separately display the folders which store contents stored in the device. That is, referring to FIG. 2, the control unit 130 controls the GUI unit 120 to allow the respective folders to have a different background color.

In this case, the control unit 130 controls the GUI unit 120 to display, on the content layer, information about user-selected contents which are stored, along different paths, in the device displayed on the device layer. For example, when the user-selected content item is music, the music is displayed on the content layer, the control unit 130 controls the GUI unit 120 to differently display, on the device layer, folders in which music files stored in the device indicated by the device layer are located.

Upon receipt of a task switching command, the control unit 130 controls the GUI unit 120 to rotate the task layer in a direction indicated by the task switching command in order to switch the task, and to display a type of the switched task. Here, the task includes all tasks supported by the electronic device 100, including slide show, album making, image editing/playing, music playing. The control unit 130 keeps the device layer and the content layer as they are and controls to rotate only the task layer when the task switching command is received.

Further, the control unit 130 organizes content folders and contents stored in the device displayed on the device layer in an order of storing date.

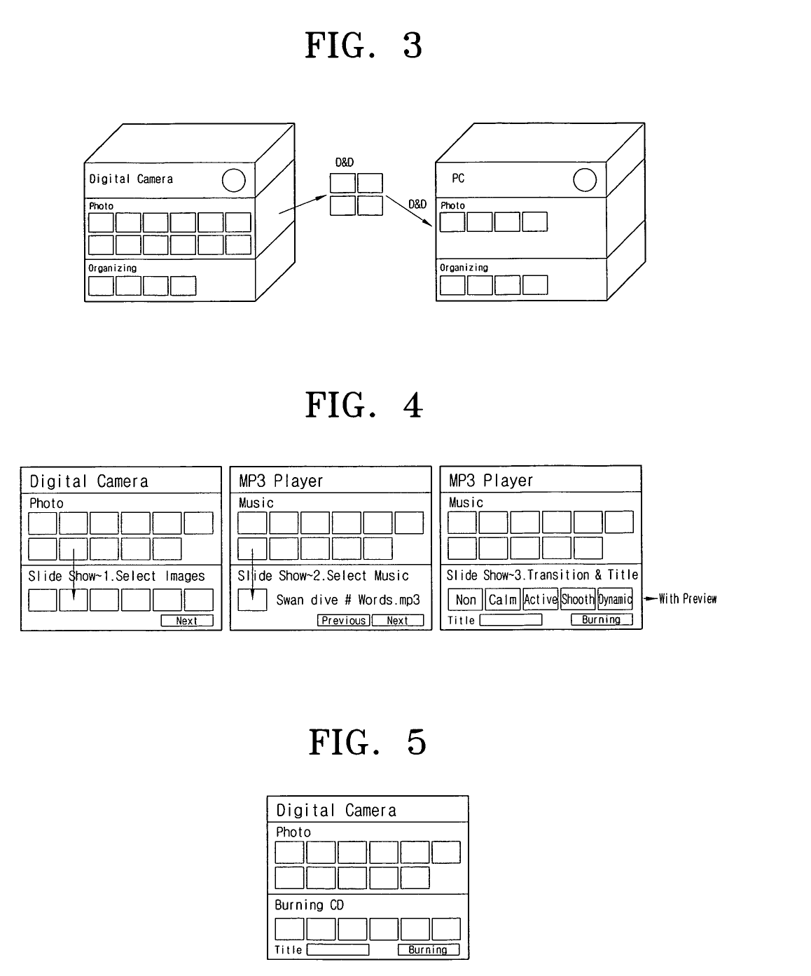

FIG. 3 is a diagram illustrating one example of a three-dimensional GUI in which a menu is operated for a function of a content layer in an electronic device according to the present invention.

Referring to FIG. 3, a digital camera is displayed on a device layer of a reference plane to a user, a still image (photo) on a content layer, and an organizing task on a task layer. Upon receipt of a device switching command from the operation unit 110, the control unit 130 controls the GUI to rotate the device layer so that the device layer of the reference plane is switched from the digital camera to a personal computer (PC).

In this case, the content layer keeps displaying the “still image”, but the content includes still images stored in the personal computer rather than the still images stored in the digital camera. In this manner, the control unit 130 controls the GUI unit 120 to switch the type of a device in response to a received device switching command and to display still images among a plurality of content items (images, still images, and texts) stored in the switched device. The control unit 130 keeps the “organizing” function for the task layer as it is, but organizes still images stored in the personal computer, similar to the content layer.

As shown in FIG. 3, when data is to be moved from one device to the other device, a user-selected content of the contents stored in the device (i.e., digital camera) set on the device layer of the reference plane is dragged and dropped according to the three-dimensional GUI displayed on the display unit 140. With operation of the operation unit 110, the device (such as a digital camera) on the device layer is then switched to the device (such as a personal computer) to which the selected content is to be moved. As the selected content is dragged and dropped to the content layer of the reference plane, the user-selected content is then moved to the switched device.

FIG. 4 is a diagram illustrating one example of a three-dimensional GUI in which a menu is operated for a function of a task layer in an electronic device according to an exemplary embodiment of the present invention.

Referring to FIG. 4, a digital camera is displayed on a device layer of a reference plane to a user, a still image on a content layer, and a slide show on a task layer.

In this case, when still images stored in the digital camera and music files stored in the MP3 player is to be played back, the control unit 130 executes slide shows for user-selected ones of the still images displayed on the content layer, an MP3 player switched in response to a device switching command and a content switching command, and user-selected ones of music files stored in the MP3 player. In this manner, user-selected ones of still-image files and user-selected ones of music files stored in other external devices can be simultaneously played back. In this case, a screen switching atmosphere can also be set when a screen is switched for a still image selected on the slide show.

Further, when the task layer indicates CD burning, the control unit 130 may store user-selected still-image files and music files in a CD by switching the device layer and the content layer for contents stored in different external devices. That is, the control unit 130 may execute a variety of types of contents selected by the user at a plurality of devices according to the set task function by switching the device layer and the content layer.

FIG. 5 is a diagram illustrating one example of a three-dimensional GUI in which a menu is operated for a function of a device layer in an electronic device according to an exemplary embodiment of the present invention.

Referring to FIG. 5, the control unit 130 controls the GUI unit 120 to display a digital camera on a device layer of a reference plane, a still image on a content layer, and CD burning on a task layer.

When still image, text, and moving-image files are to be moved from the digital camera to a CD, the control unit 130 controls the GUI unit 120 to display, on the task layer, user-selected ones of the still images displayed on the content layer. The control unit 130 controls the GUI unit 120 to switch a content item from a still image to a moving image in response to a content switching command and to accumulate and display user-selected ones of moving-image files stored in the digital camera on the task layer.

The control unit 130 also controls the GUI unit 120 to switch the content item from the moving image to a text in response to a content switching command and to accumulate and display user-selected ones of text files stored in the digital camera on the task layer. When an icon is selected on the task layer to execute CD burning, the still-image, moving-image, and text files accumulated on the task layer are stored in the CD. That is, the user-selected contents are stored in the CD by switching the content layer.

Although the three-dimensional GUI having the three layers including device, content, and task in the electronic device according to an exemplary embodiment of the present invention has been described for convenience of illustration, the present invention is not limited thereto but the three-dimensional GUI may have any number of layers.

Although the three-dimensional GUI in the electronic device according to an exemplary embodiment of the present invention has been also described as having a hexagonal pillared shape of a hexahedral structure, the present invention is not limited thereto but the three-dimensional GUI may have a polygonal pillared shape including triangular, tetragonal, and pentagonal pillared shapes. Although the respective layers of the three-dimensional GUI have also been described as having the same shape, the present invention is not limited thereto but the layers may have a different shape.

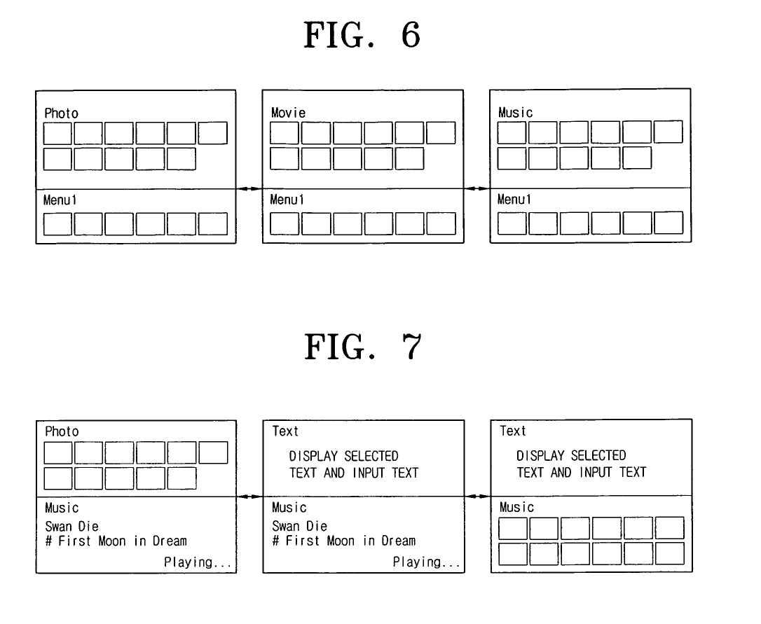

The electronic device providing the three-dimensional GUI having a plurality of layers has been described. A mobile terminal providing a two-dimensional GUI having a plurality of layers will now be described with reference to FIGS. 6 and 7.

FIG. 6 is a diagram illustrating a user interface according to another exemplary embodiment of the present invention.

Referring to FIG. 6, a reference plane of the GUI provided by a mobile terminal includes a content layer and a task layer. Similar to the three-dimensional GUI, the control unit 130 may rotate the content layer and the task layer to switch a content and a task in response to a switching command received from the operation unit 110. In this case, the control unit 130 controls the GUI unit 120 to two-dimensionally display the type of the content and the task on the display unit 140.

FIG. 7 is a diagram illustrating a two-dimensional GUI supporting multi-tasking provided according to another exemplary embodiment of the present invention. In FIG. 7, both layers are content layers in order to support multi-tasking.

Referring to FIG. 7, when a user desires to play back a plurality of contents provided by the mobile terminal, he/she selects a multi-tasking mode. The multi-tasking mode may be set using a hard button of the mobile terminal or using an icon or a menu on the two-dimensional GUI.

Upon receipt a multi-tasking mode command from the operation unit 110, the control unit 130 switches a task layer of a reference plane to be a content layer. This allows user-selected contents to be simultaneously played back.

In other words, when the user desires to play back still-image and music files stored in the mobile terminal, the control unit 130 controls to play back the user-selected still image files on the first content layer and the user-selected music files on the second content layer. That is, upon receipt of the multi-tasking mode command, the control unit 130 switches a non-content layer to a content layer so that the plurality of layers are used as content layers.

When the user desires to play back selected music files or still-image files while inputting/editing texts, the control unit 130 controls the GUI unit 120 to display texts input through the operation unit 110 on the first content layer and to play back the user-selected music/still-image files on the second content layer, thereby providing multi-tasking.

Meanwhile, in the two-dimensional GUI provided by the mobile terminal according to another exemplary embodiment of the present invention, when a plurality of layers are used as content layers, user-selected contents can be displayed on either the first content layer or the second content layer irrespective of an order of the content layers.

The multi-tasking provided by the mobile terminal according to another embodiment of the present invention may be applied to all electronic devices providing a user interface having a plurality of layers, as well as the two-dimensional GUI. Switching a plurality of layers to one specific layer allows the three-dimensional GUI in the electronic device according to an embodiment of the present invention to be applied with the multi-tasking.

Although the electronic devices providing the three-dimensional GUI and the two-dimensional GUI having a plurality of layers including the device layer, the content layer, and the task layer have been described, the present invention is not limited thereto.

Specifically, in other embodiments of the electronic device providing the GUI of a polygonal pillared structure according to an exemplary embodiment of the present invention, for example, device information on the device layer may be displayed as a user-selected one of menu items, and content information may be displayed on a first type of menu item belonging to a menu item or on a first type of submenu item belonging to a user-selected menu item. In this case, the task information may displayed on a menu item other than the menu item and the submenu item, which a submenu item belonging to either the menu item or the submenu item.

As described above, according to an exemplary embodiment of the present invention, it is possible to efficiently operate menus and to operate personalized menus according to user's preference by providing a three-dimensional GUI having a plurality of independently movable layers.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An electronic device comprising:
a graphical user interface (GUI) unit for producing a GUI, the GUI including a device layer for displaying device information using at least one of side surfaces of a first polygonal pillared shape, and a content layer for displaying content information using at least one of side surfaces of a second polygonal pillared shape; and
a control unit for controlling the GUI producing operation of the GUI unit.

2. The device of claim 1, wherein
the content layer displays at least one of a still image, a moving image, music, and text, and
the device layer displays devices including a storage medium for storing at least one of the still image, moving image, music, and text.

3. The device of claim 1, wherein
the GUI generated by the GUI unit further comprises a task layer for displaying task information using at least one of side surfaces of a third polygonal pillared shape, and
the task layer displays at least one of slide show, CD burning, and new-folder making.

4. The device of claim 1, wherein each of the first polygonal pillared and the second polygonal pillared shape is any one of a triangular pillared shape, a tetragonal pillared shape, a pentagonal pillared shape, and a hexagonal pillared shape.

5. The device of claim 1, wherein the first polygonal pillared shape and the second polygonal pillared shape have the same structure.

6. A user interface method comprising:
(a) displaying device information using at least one of side surfaces of a first polygonal pillared shape; and
(b) displaying content information using at least one of side surfaces of a second polygonal pillared shape.

7. The method of claim 6, wherein
the content layer displays at least one of a still image, a moving image, music, and text, and
the device layer displays devices including a storage medium for storing at least one of the still image, moving image, music, and text.

8. The method of claim 6, wherein step (b) comprises displaying a content corresponding to the content information displayed on the side surface of the second polygonal pillared shape among contents included in a selected device when any one of devices displayed on the side surface of the first polygonal pillared shape is selected.

9. The method of claim 6, further comprising displaying task information using at least one of side surfaces of a third polygonal pillared shape, wherein:
a task layer displays at least one of slide show, CD burning, and new-folder making.

10. An electronic device comprising:
a GUI unit for producing a GUI, the GUI including a menu for indicating a menu item using at least one of side surfaces of a first polygonal pillared shape, and a submenu for indicating a submenu item using at least one of side surfaces of a second polygonal pillared shape; and
a control unit for controlling the GUI producing operation of the GUI unit.

11. The device of claim 10, wherein the GUI generated by the GUI unit further comprises another menu for indicating another menu item using at least one of side surfaces of a third polygonal pillared shape, and
another menu is a submenu of either the menu item or the submenu item.

12. A user interface method comprising:
(a) displaying content information for a first type of contents stored in a first device when a selected one of a plurality of devices is the first device; and
(b) when the selected device is changed into a second device, displaying content information for a first type of contents stored in the second device.

13. The method of claim 12, further comprising receiving a selection of one of the first device and the second device, wherein:
step (a) comprises displaying the content information for a first type of contents stored in the first device when the selection of the first device is received, and
step (b) comprises displaying the content information for a first type of contents stored in the second device when the selection is changed from the first device to the second device.

14. An electronic device comprising:
a GUI unit for producing a GUI, the GUI including a device layer for displaying device information and a content layer for displaying content information; and
a control unit for controlling the GUI unit to display a content corresponding to a selected device when one of devices of the device layer is selected.

15. The device of claim 14, wherein the GUI generated by the GUI unit further comprises a task layer for displaying task information,
the control unit controls the GUI unit to display at least one of a still image, a moving image, music, and text on the content layer, and
the control unit controls the GUI unit to display at least one of slide show, CD burning, and new-folder making on the task layer.

16. The device of claim 14, wherein the control unit controls the GUI unit to display a content corresponding to the content type indicated on the content layer among the contents included in a selected device when any one of devices displayed on the device layer is selected.

17. A user interface method comprising:
displaying a first type of submenu belonging to the first menu item when a selected one of a plurality of menu items is a first menu item; and
when the first selected menu item is changed into a second menu item, displaying a first type of submenu belonging to the second menu item.
